(19) United States
(12) Patent Application Publication
(10) Pub. No.: US 2012/0031829 A1
(43) Pub. Date: Feb. 9, 2012

(54) OIL SPILL RECOVERY VESSEL

(76) Inventor: DAVID W. LANCASTER, Houston, TX (US)

(21) Appl. No.: 13/197,456

(22) Filed: Aug. 3, 2011

Related U.S. Application Data
(60) Provisional application No. 61/370,413, filed on Aug. 3, 2010.

(51) Int. Cl. E02B 15/04; C02F 1/40

(52) U.S. Cl. 210/242.3

(57) ABSTRACT

The oil spill recovery vessel is configured particularly for operations in relatively shallow water. The vessel is of catamaran configuration, with a large number of slowly rotating discs installed on a lateral rotary axle at the bow of the vessel. A wiper bears against each of the two surfaces of each disc, with oil residue running along the wipers being collected in a holding tank or tanks on the vessel. The oil may be pumped to other storage vessels or containers. The lateral axle on which the discs are installed is free to rise upward in the event that the discs contact a solid object or a shallow bottom. Thus, the discs are of relatively large diameter to provide relatively greater surface area across the surface of the water than is the case with vessels operating with smaller diameter discs.

### CROSS-REFERENCE TO RELATED APPLICATION

This application claims the benefit of U.S. Provisional Patent Application Ser. No. 61/370,413, filed Aug. 3, 2010.

### BACKGROUND OF THE INVENTION

1. Field of the Invention

The present invention relates generally to vessels and equipment configured for environmental cleanup work, and particularly to an oil spill recovery vessel that provides a seagoing vessel configured for recovering crude oil or the like from the surface of a body of water.

2. Description of the Related Art

The development of technology permitting the drilling of oil and natural gas wells beneath the surface of the sea has greatly expanded the field of energy recovery. While the recovery of such oil and natural gas deposits has served to expand and continue the availability of energy produced by such deposits, this technology is not without its potential problems.

When an oil well blowout or spill occurs on land, it is generally relatively easy to contain the spill and recapture the otherwise lost oil. Environmental damage is generally kept to a minimum. However, when an oil spill occurs at sea, the potential for environmental damage is considerably greater due to the freely flowing crude oil that spreads to a wide area on the surface from its source at the sea floor. Moreover, winds, currents, and tidal flow can carry such surface oil over a large expanse of the surface, eventually carrying it to broad expanses of the shoreline, perhaps extending for several hundred miles. The associated damage to wildlife, seafood sources, and other environmental concerns may be correspondingly huge.

As a result, a number of different vessels and devices have been developed in the past for recapturing waterborne oil from such oil spills. This equipment may function by means of a few different principles, e.g., floating barriers intended to keep the surface oil from spreading, materials for absorbing the oil, and machinery operated from moving vessels that are driven through the oil to recover or collect the oil on the surface.

A number of such oil recovery vessels have been developed in the past, with most having one or more large rotating drums to collect the oil on the surface(s) of the drum(s), whereupon it is removed by a wiper(s) for storage in tanks on the vessel or pumped to another storage facility. Others have been developed with discs rather than drums, with the greater surface area of the discs providing greater recovery efficiency. However, generally speaking such oil recovery vessels are configured for operation in relatively deep water. Unrecovered oil is still free to drift to shallower areas closer in to shore, where the oil poses its greatest threat.

Thus, an oil spill recovery vessel solving the aforementioned problems is desired.

### SUMMARY OF THE INVENTION

The oil spill recovery vessel has a shallow draft and is configured particularly for oil recovery missions in relatively shallow water, although it may be used in deeper water as well. The vessel has a catamaran-type hull with a closed pilothouse or cabin to protect the operators from chemical vapors arising from an oil slick on the water surface.

A large number of rotating oil recovery discs are disposed upon a lateral axle at the bow of the vessel. Wipers bear against the two opposed surfaces of each disc to remove the oil from the discs. The oil runs from the wipers to be collected in holding tanks on the vessel, where it may be transferred to other vessels or containers, as desired.

The vessel may be powered by a pair of motors, e.g., short shaft outboard motors or the like, or may be powered by inboard engines. The rotation of the discs may be powered by various means. The lateral axle with which the discs rotate floats freely to allow the discs to rise in the event that they contact a solid object or shallow bottom. This allows the discs to be of relatively large diameter, thereby providing greater surface area across the water surface to gather more oil than would be the case with smaller diameter discs. The discs rotate at a relatively slow speed in order to avoid the pickup of water with the oil residue.

These and other features of the present invention will become readily apparent upon further review of the following specification and drawings.

### BRIEF DESCRIPTION OF THE DRAWINGS

FIG. 1 is an environmental, perspective view of an oil spill recovery vessel according to the present invention, showing its general operation.

FIG. 2 is a right side elevation view of the vessel of FIG. 1, showing various details thereof.

FIG. 3 is a top plan view of the vessel of FIG. 1, showing further details.

FIG. 4 is a top plan view of the holding tank layout of the vessel of FIG. 1, showing baffling and other details.

FIG. 5 is a right side elevation view of the oil recovery disc assembly of an oil spill recovery vessel according to the present invention, showing the articulation of the disc assembly upon contacting a shallow area.

FIG. 6 is a partial side elevation view in section of the bow of the vessel of FIG. 1 and its oil recovery discs, showing the installation of the wipers and their communication with the holding tank.

FIG. 7 is a detailed end elevation view in section of a single wiper assembly for an oil spill recovery vessel according to the present invention, showing various details thereof.

Similar reference characters denote corresponding features consistently throughout the attached drawings.

### DETAILED DESCRIPTION OF THE PREFERRED EMBODIMENTS

The oil spill recovery vessel is particularly adapted for the recovery of crude oil (or other liquids floating on the surface of a body of water) from the surface of a shallow body of water. The oil recovery mechanism articulates to rise when encountering a shallow obstruction, thereby allowing the vessel to function in shallower water than conventional oil recovery vessels.

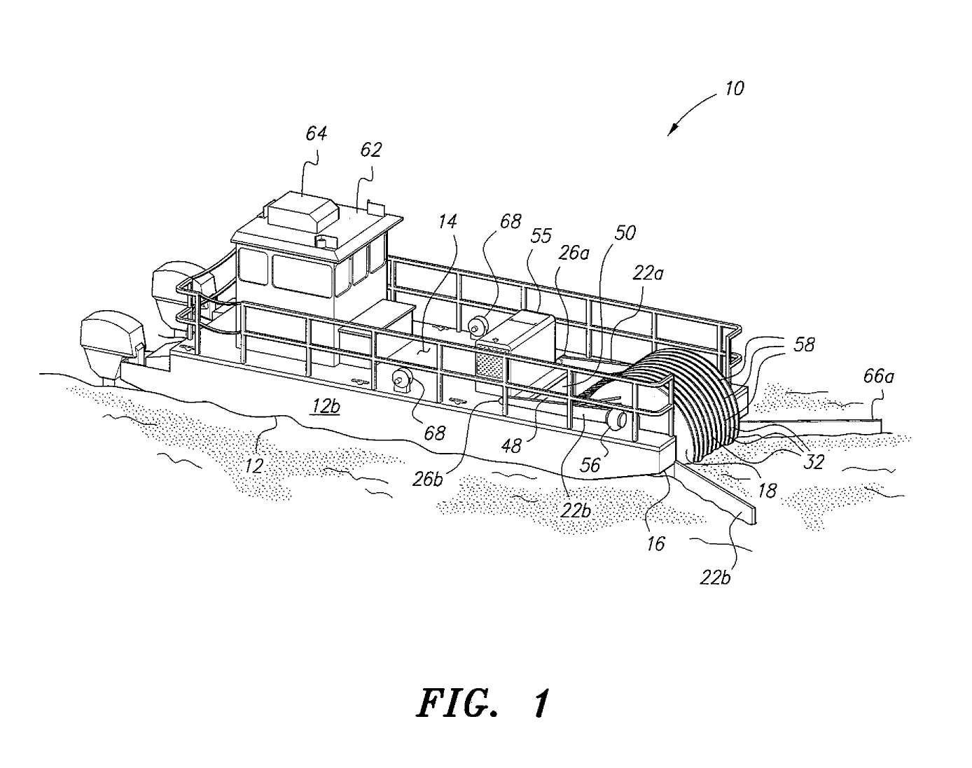

FIGS. 1 through 3 provide environmental perspective, right side elevation, and top plan views, respectively, of the oil spill recovery vessel 10. The vessel 10 has a catamaran-type hull 12, i.e., having port and starboard hull units 12a and 12b, and a deck 14 spanning the two hull units. The hull 12 has a forward end 16 defining a laterally disposed oil recovery bay 18, and an opposite aft end 20 where the propulsion unit(s) is/are situated.

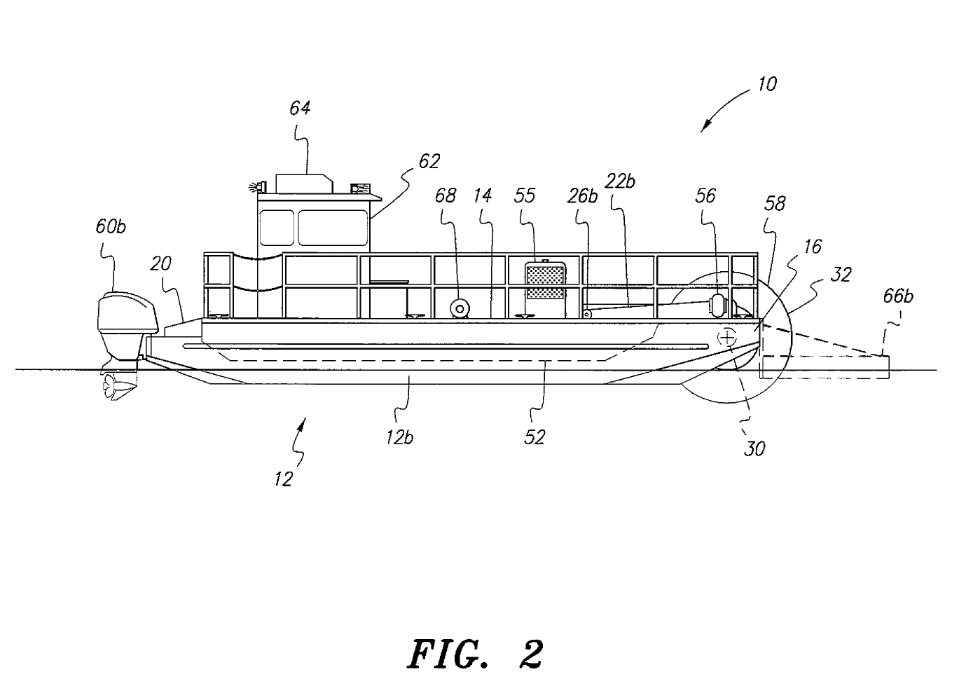

The oil recovery assembly articulates on laterally spaced first and second axle support arms 22a and 22b. Each arm 22a, 22b has a rearwardly disposed attachment end 24a, 24b pivotally attached to the hull 12 (or deck 14) by an axle support arm pivot 26a, 26b. The opposite, forwardly disposed axle support ends 28a and 28b of the arms 22a, 22b have a selectively rotating axle 30 (best seen in FIGS. 2, 5, and 6) extending laterally between the arms 22a, 22b. The axle 30 spans the lateral width of the oil recovery bay 18.

A series of laterally spaced apart oil recovery discs 32 are immovably affixed to the axle 30 so that the discs 32 rotate with rotation of the axle 30. The discs 32 are each formed of an oleophilic material, e.g., polypropylene, high-density polyethylene, or other oleophilic polymer. Oil is known to adhere to such materials, while water does not readily adhere to such plastic materials. Any material having such properties may be used for the manufacture of the discs 32. Each of the discs 32 has two mutually opposed surfaces, thus significantly increasing the surface contact area of the oil recovery unit in comparison to drum type units.

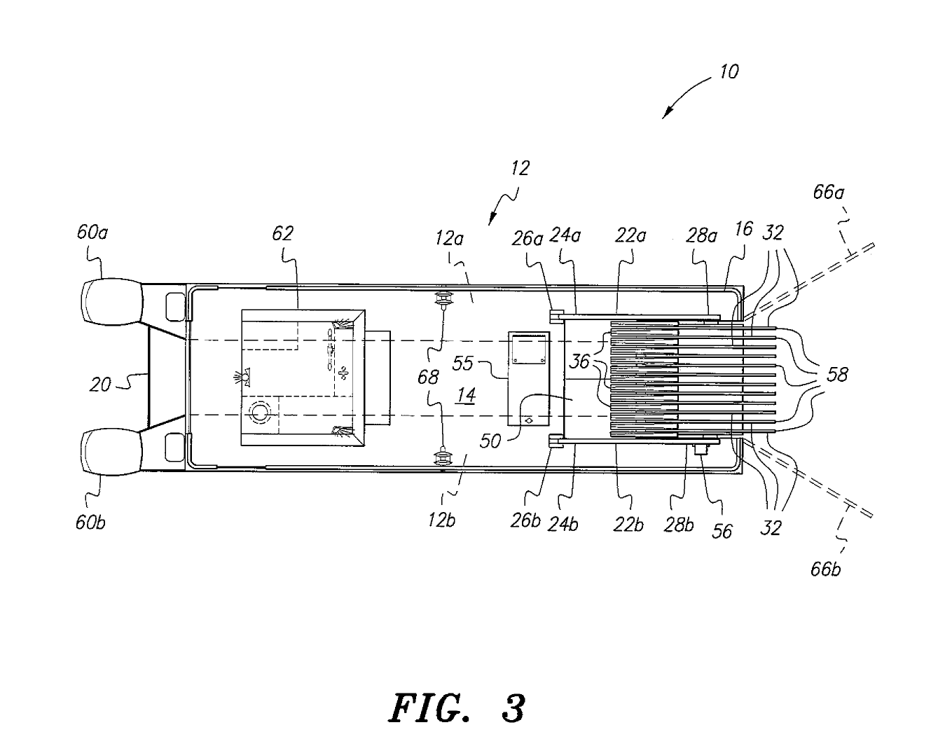

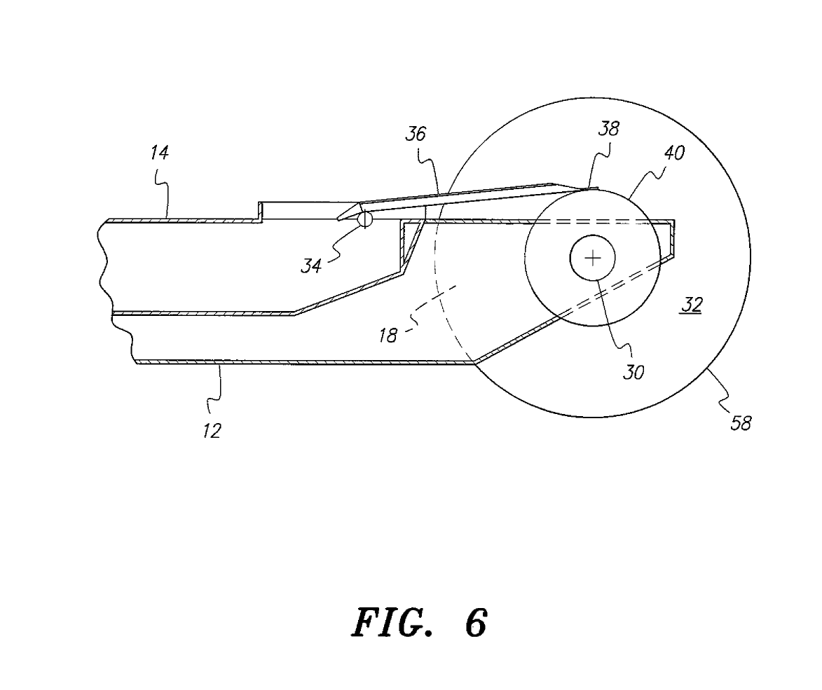

A laterally and pivotally disposed wiper axle 34 is located rearwardly of the oil recovery bay 18, as shown most clearly in FIG. 6 of the drawings. A plurality of wiper assemblies 36 extend forwardly from the wiper axle 34. The rearward end of each of the wiper assemblies 36 is immovably affixed (e.g., welded, bolted, etc.) to the wiper axle 34 to pivot in unison therewith. The top plan view of FIG. 3 clearly shows that the axle support arms 22a and 22b are significantly longer than the wiper assemblies 36, and the wiper axle 34 (shown in FIG. 6) is located correspondingly farther forward than the two axle support pivots 26a, 26b. The forward end 38 of each wiper assembly 36 rides on a spacer 40. One such spacer 40 is positioned between each of the oil recovery discs 32, and an additional spacer 40 is disposed adjacent each of the outermost discs.

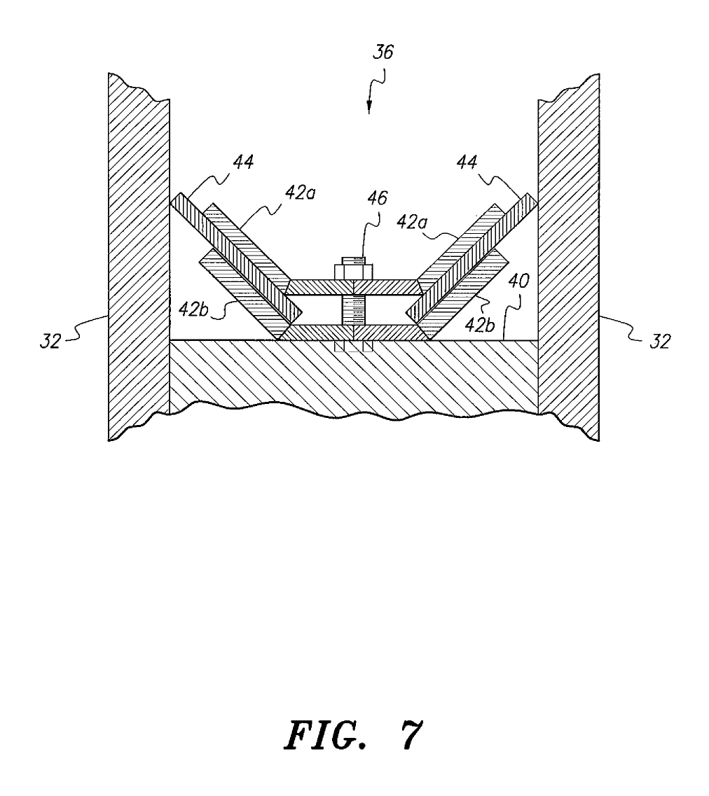

FIG. 7 provides an end elevation view in section of an exemplary wiper assembly 36 disposed between two adjacent oil recovery discs 32. Each wiper assembly 36 includes upper and lower clamps 42a and 42b that grip wiper elements 44 therebetween. A conventional bolt and nut assembly 46 or other suitable fastener is used to secure the two clamps 42a, 42b together. (The head of the bolt is behind the spacer 40, in the orientation of the FIG. 7 view.) Each of the clamps 42a, 42b preferably forms a shallow trough, with the wiper elements 44 angled laterally upward to bear against the surface of the adjacent oil recovery disc 32. In this manner, oil wiped from the surface of the disc 32 runs downward into the trough of the upper clamp 42a, and then rearward for collection as described further below.

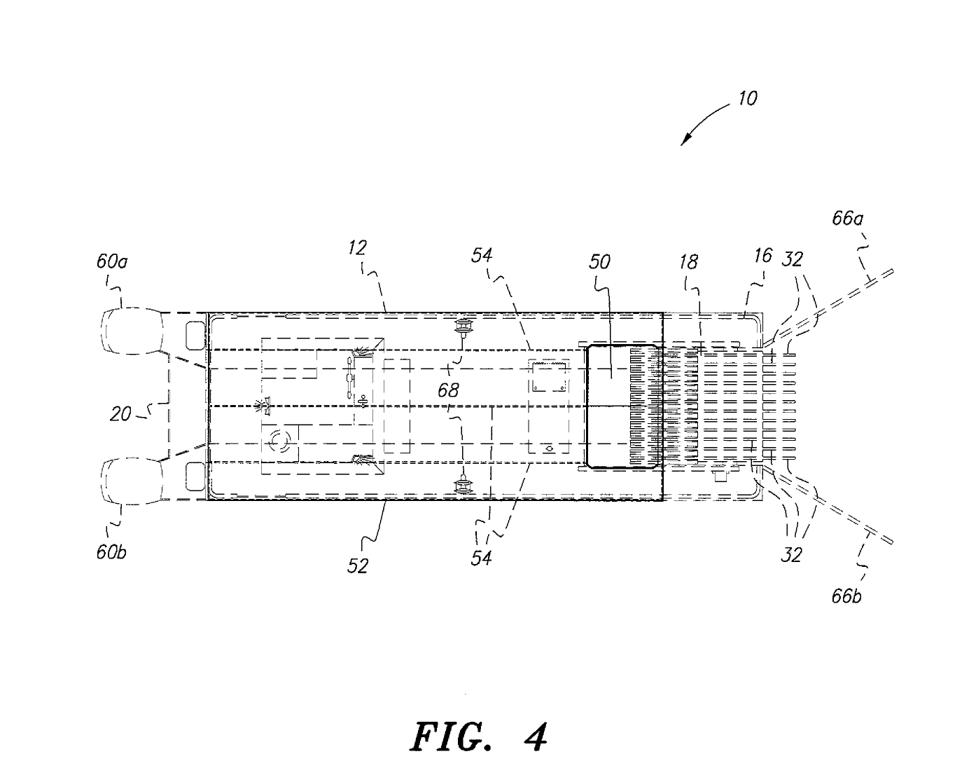

The wiper elements 44 are preferably formed of a slightly flexible plastic material, e.g., Nylon or the like. Nylon may also have an oleophilic property, as in the case of the polymers used to form the oil recovery discs 32. However, the wiper assemblies 36 slope downwardly and rearwardly toward their attachment points to the wiper axle 34, as shown in FIG. 6. When the oil accumulated by the wiper elements 44 reaches sufficient mass and volume, it will run downwardly and rearwardly from the wiper assemblies 36 to an oil recovery tray 48 (best shown in FIG. 1), running from the rear of the feed tray through a forwardly disposed opening 50 into the holding or storage tank(s) 52, best shown in FIG. 4. The holding or storage tank(s) 52 preferably include at least a few longitudinally disposed baffles 54 therein to reduce instability in roll of the vessel 10 due to lateral slosh of the relatively low viscosity recovered crude oil.

It will be understood that it is necessary to provide some form of power to rotate the axle 30 of the oil recovery discs 32, and thus the discs 32 themselves, in order for them to pick up any oil film floating atop the surface of the water. The rotary power for the oil recovery discs 32 may use any practicable principle, e.g., mechanical, hydraulic, electric, pneumatic, etc. In the exemplary system described herein, a conventional internal combustion engine is used to drive a conventional hydraulic pump, with the housing 55 of the engine and pump assembly being shown in FIGS. 1 through 3. The hydraulic pump supplies hydraulic fluid under pressure to a hydraulically driven oil recovery disc motor 56, which, in turn, drives the oil recovery discs 32 by means of the axle 30.

It is desired that the oil recovery discs 32 rotate at a relatively slow speed for optimum efficiency in oil recovery. Accordingly, the pump and/or motor 56 have one or more conventional rotational speed reducing means or low speed drives (e.g., gearboxes, chain drives, etc.) to reduce the rotational speed of the oil recovery discs 32 to the desired speed. It has been found that movement of the disc surface through the film of oil on the surface of the water at a rate of about one foot per second (more or less) is about optimum. A slower rate results in less oil recovery per unit of time, while a much faster rate will entrain water on the discs 32, resulting in the undesired water then being transferred into the holding or storage tank(s) 52 along with the desired recovered oil. With an exemplary disc diameter of about seven feet, a rotational speed on the order of 2.7 revolutions per minute will drive the rims 58 of the oil recovery discs 32 at the desired one foot per second travel speed through the surface of the water. However, it will be understood that faster or slower rates of travel of the disc rims 58 through the water may be desirable under various circumstances, e.g., the viscosity and/or other properties of the oil or other liquid being recovered, the specific material of which the discs 32 are formed, and perhaps other considerations.

The propulsion system for the exemplary vessel 10 of the present disclosure is a separate system from the power plant provided to operate the oil recovery discs 32. In the exemplary vessel 10, first and second outboard motors 60a and 60b are provided at the stern 20 of the vessel 10. These motors 60a, 60b are preferably relatively powerful outboards, and are equipped with relatively short shafts (as shown in FIG. 2 of the drawings) to facilitate operation of the vessel 10 in shallow waters, e.g., close in to the shoreline. Alternatively, other propulsive units may be provided, e.g., inboard diesel or spark ignition engines, etc., if desired.

It will be recognized that the operating environment of the oil spill recovery vessel 10 subjects the personnel on board to the evaporative byproducts of the spilled material. It has been found that prolonged breathing of such byproducts (crude oil vapors and fumes, etc.) can result in various respiration problems or difficulties for many people. Accordingly, the oil spill recovery vessel 10 is provided with an enclosed pilothouse 62 on the deck 14. Fresh, uncontaminated air may be supplied to the pilothouse 62 by means of a conventional environmental control system 64 (e.g., air conditioner and/or heat pump with, suitable air filtration, etc.) communicating with the interior of the pilothouse.

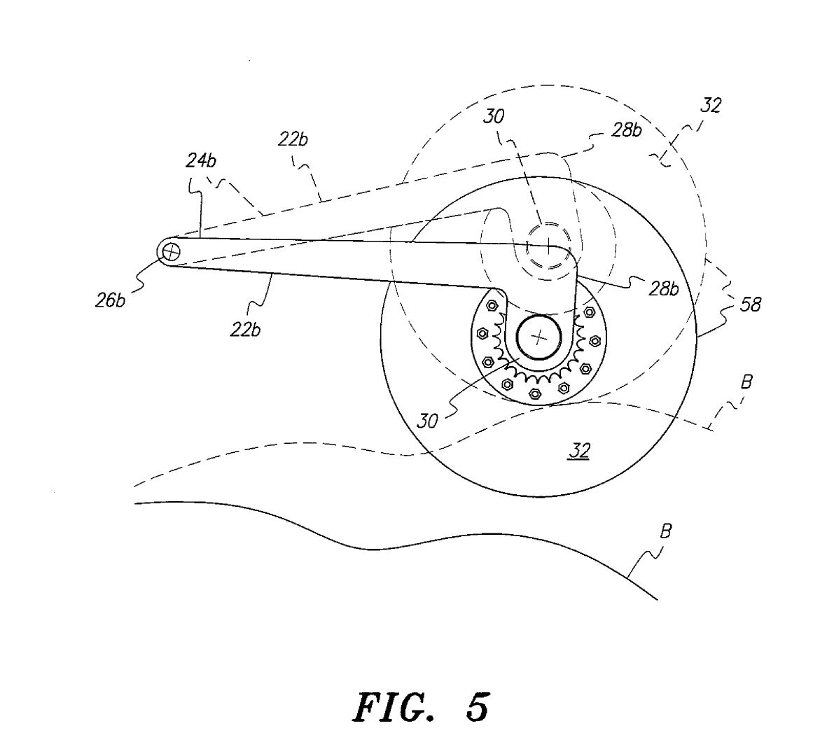

The oil spill recovery vessel 10 is suitable for the recovery of surface spills of oil and/or other liquids on virtually any body of water where operation of the vessel 10 is appropriate. However, the vessel 10 is particularly well adapted for operation in relatively shallow waters, as noted further above. The two catamaran flotation hulls 12a and 12b of the vessel 10 are relatively high in volume for the weight of the vessel, thus providing relatively shallow draft. Moreover, the oil recovery discs 32, or more specifically the arms 22a, 22b supporting the axle 30 of the discs 32, pivot or articulate upwardly and downwardly. This allows the discs 32 to rise in the event that they contact a solid object, such as the underlying shallow seabed or bottom B, as shown in broken lines in FIG. 5.

As the oil spill recovery vessel 10 operates, the spilled oil on the surface of the water is picked up by the oleophilic recovery discs 32 and carried upwardly and rearwardly around the discs 32, where it encounters the wiper assemblies 36. Additional efficiency may be provided by the installation of sweep boards 66a and 66b extending forwardly and laterally outward to each side of the oil recovery bay 18 in order to guide a lateral swath of surface oil wider than the beam of the vessel 10 into the recovery discs 32. Oil adhering to the surfaces of the discs 32 is wiped from the discs by the wiper elements 44, the oil then running downwardly and rearwardly in the troughs of the wiper assemblies 36 onto the oil recovery tray 48 and into the holding or storage tank(s) 52. The vessel 10 is capable of recovering reasonably large volumes of oil from the surface of the water, depending upon conditions (thickness of the oil film, roughness of the water surface, etc.). It is anticipated that under certain circumstances the holding or storage tank(s) 52 may be filled in perhaps five hours of operation of the vessel 10. Accordingly, one or more lightering (transfer) pump(s) 68 may be provided for the transfer of the accumulated oil to larger vessels, and thence to on-shore storage, disposal, and/or processing/refining facilities, thereby allowing the oil spill recovery vessel 10 to continue the oil spill recovery operation with maximum efficiency.

It is to be understood that the present invention is not limited to the embodiments described above, but encompasses any and all embodiments within the scope of the following claims.

I claim:

1. An oil spill recovery vessel, comprising:
a hull having a deck, a forward end having an oil recovery bay extending laterally across the forward end, and an aft end opposite the forward end;
laterally spaced apart first and second axle support arm pivots disposed rearward of the oil recovery bay;
mutually parallel first and second axle support arms, each of the support arms having an attachment end pivotally attached to a corresponding one of the axle support pivots and a forwardly disposed axle support end opposite the attachment end;
a selectively rotating axle disposed laterally across the axle support ends of the axle support arms, the axle extending laterally across the oil recovery bay;
a plurality of spaced apart oil recovery discs affixed to the axle and rotating therewith;
a pivoting wiper axle disposed laterally and rearward of the oil recovery bay, the wiper axle being disposed forward of the first and second axle support pivots; and
a plurality of wiper assemblies extending forward from the wiper axle, each of the wiper assemblies being in contact with at least one of the oil recovery discs.

2. The oil spill recovery vessel according to claim 1, further comprising:
a plurality of spacers disposed upon the axle, each of the spacers being positioned adjacent at least one of the oil recovery discs, each of the wiper assemblies having a forward end supported by a corresponding one of the spacers;
an oil recovery tray disposed rearward of the oil recovery bay, the rearward end of each of the wiper assemblies fluidly communicating with the oil recovery tray; and
at least one holding tank disposed within the hull, the oil recovery tray fluidly communicating with the at least one holding tank.

3. The oil spill recovery vessel according to claim 1, wherein each of the oil recovery discs has a rim, the oil spill recovery vessel further comprising a low speed drive communicating with the axle, the drive having a rotational speed corresponding to an oil recovery disc rim speed of between about one half foot per second and three feet per second.

4. The oil spill recovery vessel according to claim 1, further comprising:
an enclosed pilot house disposed upon the deck; and
an environmental control system communicating with the pilot house.

5. The oil spill recovery vessel according to claim 1, further comprising first and second outboard motors disposed at the aft end of the hull.

6. The oil spill recovery vessel according to claim 1, further comprising a hydraulically powered low speed drive communicating with the axle.

7. The oil spill recovery vessel according to claim 1, wherein the hull has a catamaran configuration.

8. An oil spill recovery vessel, comprising:
a hull having a deck, a forward end having an oil recovery bay disposed laterally across the forward end, and an aft end opposite the forward end;
a selectively rotating axle disposed laterally across the oil recovery bay;
a plurality of oil recovery discs affixed to the axle and rotating therewith;
a plurality of spacers disposed upon the axle, each of the spacers being positioned adjacent at least one of the oil recovery discs;
a plurality of wiper assemblies, each of the wiper assemblies being in contact with at least one of the oil recovery discs, each of the wiper assemblies having a forward end supported by a corresponding one of the spacers;
an oil recovery tray disposed rearward of the oil recovery bay, the rearward end of each of the wiper assemblies fluidly communicating with the oil recovery tray; and
at least one holding tank disposed within the hull, the oil recovery tray fluidly communicating with the at least one holding tank.

9. The oil spill recovery vessel according to claim 8, further comprising:
laterally spaced apart first and second axle support arm pivots disposed rearward of the oil recovery bay;
mutually parallel first and second axle support arms, each of the support arms having an attachment end pivotally secured to a corresponding one of the axle support pivots and a forwardly disposed axle support end opposite the attachment end, the axle being disposed laterally across the axle support ends of the axle support arms; and
a pivoting wiper axle disposed laterally and rearward of the oil recovery bay, the wiper axle being disposed forward of the first and second axle support pivots, the wiper assemblies extending forward from the wiper axle.

10. The oil spill recovery vessel according to claim 8, wherein each of the oil recovery discs has a rim, the oil spill recovery vessel further comprising a low speed drive communicating with the axle, the drive having a rotational speed corresponding to an oil recovery disc rim speed of between about one half foot per second and three feet per second.

11. The oil spill recovery vessel according to claim 8, further comprising:
an enclosed pilot house disposed upon the deck; and
an environmental control system communicating with the pilot house.

12. The oil spill recovery vessel according to claim 8, further comprising first and second outboard motors disposed at the aft end of the hull.

13. The oil spill recovery vessel according to claim 8, further comprising a hydraulically powered low speed drive communicating with the axle.

14. The oil spill recovery vessel according to claim 8, wherein the hull has a catamaran configuration.

15. An oil spill recovery vessel, comprising:
a hull having a deck, a forward end having an oil recovery bay disposed laterally across the forward end, and an aft end opposite the forward end;
a selectively rotating axle disposed laterally across the oil recovery bay;
a plurality of spaced apart oil recovery discs affixed to the axle and rotating therewith, each of the oil recovery discs having a rim;
a plurality of wiper assemblies, each of the wiper assemblies being in contact with at least one of the oil recovery discs; and
a hydraulically powered low speed drive communicating with the axle, the drive having a rotational speed corresponding to an oil recovery disc rim speed of between about one half foot per second and three feet per second.

16. The oil spill recovery vessel according to claim 15, further comprising:
laterally spaced apart first and second axle support arm pivots disposed rearward of the oil recovery bay;
mutually parallel first and second axle support arms, each of the support arms having an attachment end pivotally secured to a corresponding one of the axle support pivots and a forwardly disposed axle support end opposite the attachment end, the axle being disposed laterally across the axle support ends of the axle support arms; and
a pivoting wiper axle disposed laterally and rearward of the oil recovery bay, the wiper axle being pivotally secured to the hull forwardly of the first and second axle support pivots, the wiper assemblies extending forward from the wiper axle.

17. The oil spill recovery vessel according to claim 15, further comprising:
a plurality of spacers disposed upon the axle, each of the spacers being positioned adjacent at least one of the oil recovery discs, each of the wiper assemblies having a forward end supported by a corresponding one of the spacers;
an oil recovery tray disposed rearward of the oil recovery bay, the rearward end of each of the wiper assemblies fluidly communicating with the oil recovery tray; and
at least one holding tank disposed within the hull, the oil recovery tray fluidly communicating with the at least one holding tank.

18. The oil spill recovery vessel according to claim 15, further comprising:
an enclosed pilot house disposed upon the deck; and
an environmental control system communicating with the pilot house.

19. The oil spill recovery vessel according to claim 15, further comprising first and second outboard motors disposed at the aft end of the hull.

20. The oil spill recovery vessel according to claim 15, wherein the hull has a catamaran configuration.
